(19) United States
(12) Patent Application Publication
(10) Pub. No.: US 2017/0270444 A1
(43) Pub. Date: Sep. 21, 2017

(54) APPLICATION EVALUATION

(71) Applicant: HEWLETT PACKARD ENTERPRISE DEVELOPMENT LP, Houston, TX (US)

(72) Inventors: Reinier J. AERDTS, Plano, TX (US); Parag M. DOSHI, Marietta, GA (US); Chandra H. KAMALAKANTHA, Plano, TX (US)

(73) Assignee: HEWLETT PACKARD ENTERPRISE DEVELOPMENT LP, Houston, TX (US)

(21) Appl. No.: 15/329,985

(22) PCT Filed: Sep. 5, 2014
(86) PCT No.: PCT/US2014/054429

§ 371 Date: Jan. 27, 2017

(51) Int. Cl. G06Q 10/06; G06F 9/445

(52) U.S. Cl. CPC G06Q 10/0639; G06F 8/60

(57) ABSTRACT

In one implementation, a method comprises receiving an objective of a business, searching an application repository to automatically identify an application in the application repository that is associated with the received objectives, receiving metrics for the application and outputting an objective evaluation of the application based on the received metrics and the received objectives. In one implementation, usage of a plurality of applications is monitored to identify usage patterns for each of the plurality of applications. The identified usage patterns are compared with received business objectives and an objective evaluation is output for each of the applications based upon the comparison, the objective evaluation serving as a basis for maintaining, discontinuing or re-architecting the applications.

### BACKGROUND

Businesses and industries have experienced a proliferation of information technology applications. Many of such applications are redundant or do not best serve the objectives of the business or industry. As a result, business objectives and information technology applications are often out of alignment.

### BRIEF DESCRIPTION OF THE DRAWINGS

FIG. 1 is a schematic diagram of an example application evaluation system.

FIG. 2 is a flow diagram of an example method for evaluating an application.

FIG. 3 is a schematic diagram of another example application evaluation system.

FIG. 4 is a flow diagram of another example method for evaluating an application

### DETAILED DESCRIPTION OF EXAMPLES

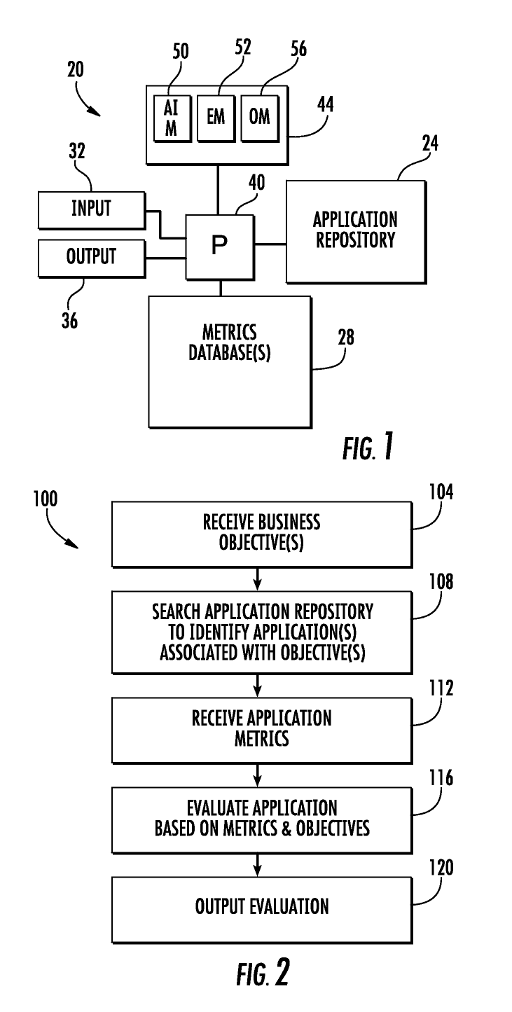

FIG. 1 schematically illustrates an example application evaluation system 20. Application evaluation system 20 evaluates applications of a business in terms of the objectives of the business. Application evaluation system 20 facilitates the identification of applications that should be maintained, applications that should be replaced and applications that should be re-architected.

In the example illustrated, application evaluation system 20 comprises application repository 24, metrics database 28, input 32, output 36, processor 40 and memory 44. Application repository 24 comprises at least one persistent storage device or database in which various enterprise applications for a business reside. In one implementation, application repository comprises multiple enterprise applications that are managed by an enterprise service management host, wherein each application has an associated file or an associated set of fields that is periodically updated with data such as ownership data, usage data and the like. In one implementation, application repository comprises databases that are distributed amongst various locations or sites.

Metric database 28 comprises at least persistent storage device or location storing metrics for the applications residing in repository 24 are stored. In one implementation, metric database 28 stores survey results or information obtained from surveys regarding the applications of repository 24. Such survey results may indicate customer satisfaction and other data that may not be easily obtained from simply monitoring usage of the applications. The survey results are associated or linked with each individual application contained in repository 24. In one implementation, metric database 24 is distributed amongst various database locations. In one implementation, metric database 24 is part of application repository 24, where the survey results another acquired data or directly linked to the applications in repository 24.

Input 32 comprises a device by which business objectives are input to system 20. In one implementation input 32 comprises a keyboard, touchscreen, touchpad, microphone with associated speech recognition software or other input devices. In one implementation, input 32 additionally or alternatively comprises imager data capturing devices by which documents or memory storage devices containing business requirements and technical requirements are read.

Output 36 comprises a device upon which the evaluation is presented for use. In one implementation, output 36 comprises a display screen, allowing the results of the evaluation, such as results embodied in an evaluation report, are presented for viewing by decision-maker. In one implementation to output before comprises a touch screen, wherein both input 32 and output 36 are served by the touchscreen. In one implementation, output 36 comprises a persistent memory or data storage device in which results of the evaluation or recorded for later retrieval and use.

Processor 40 comprises at least one processing unit to carry out instructions provided in memory 44 for identifying applications to be evaluated and then evaluating such applications so as to provide guidance regard to the value of each identified application with respect to particular business objectives. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Unless otherwise specifically noted, processor 40 is not limited to any specific combination of hardware circuitry and software, nor to any particular source for the instructions executed by the processing unit.

Memory 44 comprises a non-transitory computer-readable medium containing software, code, instructions or other program logic for instructing or directing processor 40 to carry out various search operations with respect to repository 24 and database 28 based upon a business objective or multiple business objectives received through input 32 so as to heuristically evaluate the particular identified applications with respect to the business objectives. In the example illustrated, memory 44 comprises application identification module 50, evaluation module 52, and output module 56. Application identification module 50, evaluation module 52 and output module 56 direct processor 40 to carry out the example method 100 outlined in the flow diagram of FIG. 2.

Application identification module 50 comprises programmed logic that directs processor 40 to receive input, through input 32, indicating at least one business objective of a business, as indicated by block 104 in FIG. 2. Such business objectives may comprise availability objectives, operational objectives, customer satisfaction objective, cost objectives, or other objectives that fit within the business's overall current strategy.

As indicated by block 108 in FIG. 2, application identification module 50 directs processor 40 to utilize such received business objectives in the formulation of a keyword search or data field search in application repository 24 and/or metric database 28. In one implementation, application identification module 50 directs processor 40 to search the associated fields for each application and application repository 24 as well as the data fields linked are associated with the identified application in metrics database 28. The identified enterprise services application is selected for evaluation.

Evaluation module 52 comprises programmed logic that directs processor 40 to receive or retrieve metrics for the identified enterprise services application, as indicated by block 112 in FIG. 2. In one implementation, evaluation module 52 retrieves values for metrics for the identified application from application repository 24 and from metrics database 28. Examples of metrics that may be used to evaluate the identified application include, but are not limited to, total cost of ownership, application usage patterns, revenue generation, competitive advantage, probability of application growth, technological maturity, application availability, application agility, ease-of-use, customer satisfaction, standard conformance and support incidents.

In one implementation, evaluation monitor 52 automatically retrieves such metrics from various sources. For example, in one implementation, evaluation monitor 52 automatically accesses application management databases to retrieve usage patterns for the application, such as frequency of use for the application, times in which the application is used, availability of the enterprise services application (percent downtime), by whom the application is used, revenue generated by use of the application, cost of ownership such as CPU usage by enterprise services application, maintenance and upkeep costs, support Center costs and the like.

In one implementation, evaluation monitor 52 automatically accesses user databases and transmit surveys to identified users, wherein evaluation monitor 52 categorizes and utilize such survey information as a metric for evaluating the identified application. Such survey information may indicate subjective metrics such as ease-of-use, customer satisfaction and the like. In one implementation, evaluation monitor 52 automatically transmits information requests or surveys to business representatives to obtain metrics regarding application or technology maturity such as a probability of application growth (the likelihood that the particular application will grow in importance or usage in the future). Such metrics regarding application of technology maturity are also derived from usage patterns over time, wherein a trend of increasing use may indicate further growth in the future. In one implementation, evaluation monitor 52 additionally automatically outputs information requests or surveys to information technology staff of a host managing enterprise services application, wherein such information requests garner information regarding application agility, the ability application to be updated, modified or be increasing capacity, or the number of support incidents. In one implementation, the number of supportive incidents is retrieved from application usage records. In one implementation of such metrics received are in the form of numerical scores are numerical values, facilitating subsequent output of an evaluation score by evaluation module 52.

As indicated by block 116 of FIG. 2, evaluation monitor 52 utilizes the received metrics for the identified application to perform an objective evaluation of the evaluation. Such an evaluation involves a comparison by processor 40 of the metrics to the received business objectives for which the identified application is being evaluated. In one implementation in which multiple business objectives are concurrently being evaluated, evaluation monitor 52 prompts users to input a ranking or prioritization of each of the business objectives, wherein evaluation monitor 52 direct processor 40 to apply a weighting scheme to the different business objectives for which the applications are being evaluated. In one implementation, the evaluation of the identified application is performed in the context of identifying whether the particular enterprise services application should be maintained, discontinued or re-architected.

Output module 56 comprises programmed logic that directs processor 40 to take action utilizing the evaluation produced by evaluation monitor 52, as indicated by block 120 in FIG. 2. In one implementation, module 56 directs processor 40 to output the results of the evaluation to output 36. In one implementation, the results comprise a numerical evaluation or justification score which is printed out by output 36, presented on display screen of output 36 or stored in a database associate with the application. In one implementation, such numerical evaluation scores are stored in a non-transitory memory, wherein the output comprises graphical presentation of scores for the particular application over time.

In one implementation, evaluation is output an output 36 in the form of a recommendation indicating whether the particular enterprise services application should be maintained, discontinued or re-architected. In one mode of operation, the recommendation is based upon an individual evaluation score or the current evaluation score. In another mode of operation, the recommendation is based upon an evaluation of the evaluation scores over time. For example, a particular application may have a low poor evaluation score, but the recommendation may be to maintain the application if the evaluation scores over a predefined period of time reflect an upward are growing trend.

In one implementation, output module 56 directs processor 40 to automatically carry out or implement at least partial re-architecting of the identified enterprise services application based upon the results of the evaluation. For example, in one implementation, metrics database 28 or another non-transitory memory or persistent storage device associated with system 20 comprises a list of business objectives and associated preprogrammed modification routines which are automatically triggered in response to an application receiving an evaluation score below a predefined threshold for the particular business objective. In such an implementation, in response to receiving an unsatisfactory evaluation score or evaluation score falling below a predefined threshold value associated with the business objective or objectives for which the identified application is being evaluated, output module 56 automatically triggers a re-architecture or modification of the application receiving the evaluation score, wherein the modifications carried out according to the preprogrammed modification routine or process pre-assigned to the particular business objective or objectives. For example, such an automatic modification may comprise automatically changing or switching over the identified application to different information technology hardware or systems.

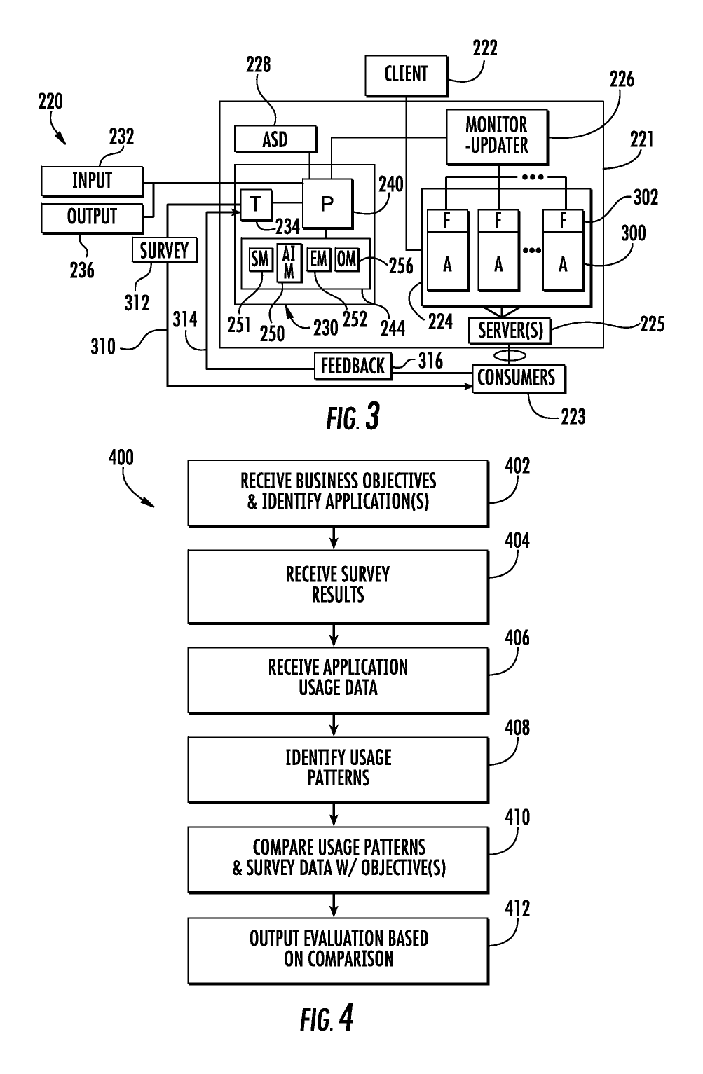

FIG. 3 schematically illustrates application evaluation system 220, another example implementation of application evaluation system 20. Like system 20, system 220 outputs a computer-generated and carried out evaluation for applications for a business. System 220 comprises enterprise services host 221 which hosts various applications for a business or client 222, wherein the applications service consumers 223. Enterprise services host 221 comprises application repository 224, servers 225, monitor-updater 226, application survey database 228, and application evaluator 230.

Application repository 224 comprises at least one persistent storage device or database in which various enterprise applications for the business or client 222 aside. In the example illustrated, application repository comprises multiple enterprise applications 300 that are managed by an enterprise service management host, wherein each application 300 has an associated file or an associated set of fields 302 that is periodically updated by monitor-updater device 226 with data such as ownership data, usage data and the like. As will be described hereafter, information or data infield 302 is used by applications evaluator 230 to evaluate applications 300. In one implementation, application repository to 24 comprises databases that are distributed amongst various locations or sites.

Application survey database 228 comprises aim non-transitory computer readable medium or memory which stores information received back from surveys transmitted to client 222, consumers 223 and information technology specialists associate with host 221. Information contained in database 228 is associate assigned to each individual application 300. As will be described hereafter, such information is utilized by application evaluator 232 evaluate applications 300.

Application evaluator 230 evaluates applications within repository 224. In one implementation, application evaluator 230 automatically evaluate applications 300 on a predefined periodic basis. In one implementation, application evaluator 230 automatically evaluates applications 300 with regard to a specific predefined business objective or set of business objectives on a predefined periodic basis.

Application evaluator 230 comprises input 232, transceiver 234, output 236, processor 240 and memory 244. Input 232 comprises a device by which business objectives of client 222 are input to system 20. In one implementation input 232 comprises a keyboard, touchscreen, touchpad, microphone with associated speech recognition software or other input devices. In one implementation, input 232 additionally or alternatively comprises imager data capturing devices by which documents or memory storage devices containing business requirements and technical requirements are read.

Transceiver 234 comprises a communication device by which application evaluator 230 communicates with clients 222. In one implementation, transceiver 234 facilitates wireless communication through a wide area network, such as the Internet, to consumers to 23. As will be described hereafter, transceiver 234 facilitates a gathering of information through the use of information requests or surveys from consumers 223, wherein such information is utilized by application evaluator 230.

Output 236 comprises a device upon which the evaluation is presented for use. In one implementation, output 36 comprises a display screen, allowing the results of the evaluation, such as results embodied in an evaluation report, are presented for viewing by decision-maker. In one implementation to output before comprises a touch screen, wherein both input 232 and output 236 are served by the touchscreen. In one implementation, output 236 comprises a persistent memory or data storage device in which results of the evaluation or recorded for later retrieval and use.

Processor 240 comprises at least one processing unit to carry out instructions provided in memory 44 for monitoring usage of applications 300, automatically obtaining or acquiring survey information, identifying applications to be evaluated and then evaluating such applications so as to provide guidance regard to the value of each identified application with respect to particular business objectives of client 222.

Memory 244 comprises a non-transitory computer-readable medium containing software, code, instructions or other program logic for instructing or directing processor 240 to carry out various search operations with respect to repository 224 and database 228 based upon a business objective or multiple business objectives received through input 232 so as to objectively evaluate, through the use of a computer evaluation program, algorithm or the like, the particular identified applications with respect to the business objectives of client to 22. In the example illustrated, memory 244 comprises application identification module 250, survey module 251, evaluation module 252, and output module 256. Application identification module 250, survey module 248, evaluation module 252 and output module 256 direct processor 240 to carry out the example method 400 outlined in the flow diagram of FIG. 4.

Application identification module 250 comprises programmed logic that directs processor 240 to receive input, through input 232, indicating at least one business objective of client 222. Such business objectives may comprise availability objectives, operational objectives, customer satisfaction objective, cost objectives, or other objectives that fit within the business's overall current strategy.

Application identification module 250 directs processor 240 to utilize such received business objectives in the formulation of a keyword search or data field search in the fields 302 in application repository 224 and/or application survey database 228. In one implementation, application identification module 250 directs processor 240 to search the associated fields 302 for each application in application repository 24 as well as the data fields linked are associated with the identified application 300 in application survey database 228. The identified enterprise services application is selected for evaluation.

Survey module 248 comprises programmed logic the direct processor 240 to acquire information through information requests or survey requests for the identified application, as indicated by block 404 in FIG. 4. In one implementation, survey module 248 direct processor 240 to formulate a survey specifically focusing on gathering metrics for the particular business objective or searches for and retrieves a predefined survey or request for information from a database of candidate information requests or surveys, based upon the received business objective. As indicated by arrow 310, the formulated or identified information request or survey 312 is transmitted or broadcast to consumers 223. As indicated by arrow 314, the information or survey feedback 316 is transmitted back to application evaluator 230. Survey module 251 direct processor 250 to receive such information and populate application survey database 228 with such information. The information stored in application survey database 228 is assigned to the particular individual application 300 for which a survey information is relevant.

Evaluation module 252 comprises programmed logic that directs processor 240 to receive or retrieve metrics for the identified enterprise services application. In one implementation, evaluation module 252 retrieves values for metrics for the identified application from application repository 224 and from metrics database 228. Examples of metrics that may be used to evaluate the identified application include, but are not limited to, total cost of ownership, application usage patterns, revenue generation, competitive advantage, probability of application growth, technological maturity, application availability, application agility, ease-of-use, customer satisfaction, standard conformance and support incidents.

In one implementation, evaluation monitor 252 automatically retrieves such metrics from various sources. For example, in one implementation, evaluation monitor 252 automatically accesses application management databases to retrieve usage patterns for the application, such as frequency of use for the application, times in which the application is used, availability of the enterprise services application (percent downtime), by whom the application is used, revenue generated by use of the application, cost of ownership such as CPU usage by enterprise services application, maintenance and upkeep costs, support center costs and the like.

In one implementation, evaluation monitor 252 automatically accesses user databases and transmit surveys to identified users, wherein evaluation monitor 252 categorizes and utilize such survey information as a metric for evaluating the identified application. Such survey information may indicate subjective metrics such as ease-of-use, customer satisfaction and the like. In one implementation, evaluation monitor 52 automatically transmits information requests or surveys to business representatives to obtain metrics regarding application or technology maturity such as a probability of application growth (the likelihood that the particular application will grow in importance or usage in the future). Such metrics regarding application of technology maturity are also derived from usage patterns over time, wherein a trend of increasing use may indicate further growth in the future. In one implementation, evaluation monitor 52 additionally automatically outputs information requests or surveys to information technology staff of a host managing enterprise services application, wherein such information requests garner information regarding application agility, the ability application to be updated, modified or be increasing capacity, or the number of support incidents. In one implementation, the number of supportive incidents is retrieved from application usage records. In one implementation of such metrics received are in the form of numerical scores are numerical values, facilitating subsequent output of an evaluation score by evaluation module 252.

Evaluation monitor 52 utilizes the received metrics for the identified application to perform an objective evaluation of the evaluation. Such an evaluation involves a comparison by processor 240 of the metrics to the received business objectives for which the identified application is being evaluated. In one implementation in which multiple business objectives are concurrently being evaluated, evaluation monitor 252 prompts users to input a ranking or prioritization of each of the business objectives, wherein evaluation monitor 252 direct processor 240 to apply a weighting scheme to the different business objectives for which the applications are being evaluated. In one implementation, the evaluation of the identified application is performed in the context of identifying whether the particular enterprise services application should be maintained, discontinued or re-architected.

Output module 256 comprises programmed logic that directs processor 40 to take action utilizing the evaluation produced by evaluation monitor 252. In one implementation, module 256 directs processor 240 to output the results of the evaluation to output 36. In one implementation, the results comprise a numerical evaluation or justification score which is printed out by output 236, presented on display screen of output 36 or stored in a database associate with the application. In one implementation, such numerical evaluation scores are stored in a non-transitory memory, wherein the output comprises graphical presentation of scores for the particular application over time.

In one implementation, evaluation is output an output 236 in the form of a recommendation indicating whether the particular enterprise services application should be maintained, discontinued or re-architected. In one mode of operation, the recommendation is based upon an individual evaluation score or the current evaluation score. In another mode of operation, the recommendation is based upon an evaluation of the evaluation scores over time. For example, a particular application may have a low poor evaluation score, but the recommendation may be to maintain the application if the evaluation scores over a predefined period of time reflect an upward are growing trend.

In one implementation, output module 256 directs processor 240 to automatically carry out or implement at least partial re-architecting of the identified enterprise services application based upon the results of the evaluation. For example, in one implementation, metrics database 228 or another non-transitory memory or persistent storage device associated with system 220 comprises a list of business objectives and associated preprogrammed modification routines which are automatically triggered in response to an application receiving an evaluation score below a predefined threshold for the particular business objective. In such an implementation, in response to receiving an unsatisfactory evaluation score or evaluation score falling below a predefined threshold value associated with the business objective or objectives for which the identified application is being evaluated, output module 256 automatically triggers a re-architecture or modification of the application receiving the evaluation score, wherein the modifications carried out according to the preprogrammed modification routine or process pre-assigned to the particular business objective or objectives. For example, such an automatic modification may comprise automatically changing or switching over the identified application to different information technology hardware or systems.

FIG. 4 is a flow diagram of an example method 400 for evaluating applications. In one implementation come method 400 is carried out by application evaluation system 220. As indicated by block 402, application evaluator 230 prompts for or receives the business objective or objectives of client 222. Such business objectives may comprise availability objectives, operational objectives, customer satisfaction objective, cost objectives, or other objectives that fit within the business's overall current strategy.

As indicated by block 304, application evaluator 230 further receives survey results. Such survey results reside in application survey database 228. As indicated by block 406, application evaluator 230 additionally obtains usage information regarding the application identified for evaluation. In one implementation, such information is stored in fields 302 associate with the particular identified application 300 and repository 224.

As indicated by block 408, evaluation module 252 of application evaluator 230 identifies usage patterns from the application usage data. As indicated by block 410, evaluation monitor 252 compares the usage patterns and the received application survey data with the received business objective or objectives of client 222. This comparison yields an objective evaluation. In one implementation in which multiple business objectives are concurrently being evaluated, a weighting scheme is applied to the different business objectives for which the applications are being evaluated. In one implementation, the evaluation of the identified application is performed in the context of identifying whether the particular enterprise services application should be maintained, discontinued or re-architected.

As indicated by block 412, the results of the evaluation are output to output 236. In one implementation, the results comprise a numerical evaluation or justification score which is printed out by output 236, presented on display screen of output 236 or stored in a database associate with the application. In one implementation, such numerical evaluation scores are stored in a non-transitory memory, wherein the output comprises graphical presentation of scores for the particular application over time.

In one implementation, evaluation is output an output 236 in the form of a recommendation indicating whether the particular enterprise services application should be maintained, discontinued or re-architected. In one mode of operation, the recommendation is based upon an individual evaluation score or the current evaluation score. In another mode of operation, the recommendation is based upon an evaluation of the evaluation scores over time. For example, a particular application may have a low poor evaluation score, but the recommendation may be to maintain the application if the evaluation scores over a predefined period of time reflect an upward are growing trend.

In one implementation, re-architecture of the application being evaluated is automatically carried out or implemented based upon the results of the evaluation. For example, in one implementation, application evaluator 230 accesses a database comprising a list of business objectives and associated preprogrammed modification routines which are automatically triggered in response to an application receiving an evaluation score below a predefined threshold for the particular business objective. In such an implementation, in response to receiving an unsatisfactory evaluation score or evaluation score falling below a predefined threshold value associated with the business objective or objectives for which the identified application is being evaluated, application evaluator 230 automatically triggers a re-architecture or modification of the application receiving the evaluation score, wherein the modifications carried out according to the preprogrammed modification routine or process pre-assigned to the particular business objective or objectives. For example, such an automatic modification may comprise automatically changing or switching over the identified application to different information technology hardware or systems.

While the preferred embodiments of the invention have been illustrated and described, it will be appreciated that various changes can be made therein without departing from the spirit and scope of the invention. For example, although different example embodiments may have been described as including one or more features providing one or more benefits, it is contemplated that the described features may be interchanged with one another or alternatively be combined with one another in the described example embodiments or in other alternative embodiments. One of skill in the art will understand that the invention may also be practiced without many of the details described above. Accordingly, it will be intended to include all such alternatives, modifications and variations set forth within the spirit and scope of the appended claims. Further, some well-known structures or functions may not be shown or described in detail because such structures or functions would be known to one skilled in the art. Unless a term is specifically and overtly defined in this specification, the terminology used in the present specification is intended to be interpreted in its broadest reasonable manner, even though may be used conjunction with the description of certain specific embodiments of the present invention.

What is claimed is:

1. A method comprising:
receiving an objective of a business;
searching an application repository to automatically identify an application in the application repository that is associated with the received objectives;
receiving metrics for the application; and
outputting an objective evaluation of the application based on the received metrics and the received objectives.

2. The method of claim 1, wherein the received metrics from the application are selected from a group of metrics consisting of: total cost of ownership; application usage patterns; revenue generation; competitive advantage; probability of application growing; technology maturity; application availability; application agility; ease-of-use; customer satisfaction; ease-of-use, conformance with standards; and support incidents.

3. The method of claim 2 wherein the received metrics comprise numerical scores or numerical values.

4. The method of claim 1 further comprising monitoring usage of the application, wherein one of the receipt metrics comprises data based upon the monitored usage of the application.

5. The method of claim 1 further comprising automatically making recommendations for how to re-architect the application based upon the evaluation.

6. The method of claim 5 further comprising:
searching a repository to identify alternative applications associated with the received objectives;
comparing the alternative applications to the application to identify a placement application from the alternative applications based upon the received objectives; and
outputting a recommendation to replace the application with the replacement application.

7. The method of claim 1 further comprising:
searching a repository to identify alternative applications associated with the received objectives;
comparing the alternative applications to the application to identify a placement application from the alternative applications based upon the received objectives; and
automatically deploying the replacement application in place of the application.

8. An apparatus comprising:
a display;
a processor;
an application repository storing application descriptors;
a non-transitory computer-readable medium containing programmed logic to direct the processor to:
retrieve a business objective;
search the application repository to automatically identify an application in the application repository that is associated with the retrieved objective;
retrieve metrics for the application; and
output an objective evaluation of the application based on the received metrics and the received objectives.

9. The apparatus of claim 8, wherein the retrieved metrics from the application are selected from a group of metrics consisting of: total cost of ownership;
application usage patterns; revenue generation; competitive advantage; probability of application growing; technology maturity; application availability; application agility;
ease-of-use; customer satisfaction; ease-of-use, conformance with standards; and support incidents.

10. The apparatus of claim 9 wherein the retrieved metrics comprise numerical scores or numerical values.

11. The apparatus of claim 8, wherein the program logic is further to direct the processor to monitor usage of the application, wherein one of the receipt metrics comprises data based upon the monitored usage of the application.

12. The apparatus of claim 8 further comprising automatically re-architecting the application based upon the evaluation.

13. The apparatus of claim 8 further comprising:
searching a repository to identify alternative applications associated with the received objectives;
comparing the alternative applications to the application to identify a placement application from the alternative applications based upon the received objectives; and
outputting a recommendation to replace the application with the replacement application.

14. An apparatus comprising:
a non-transitory computer-readable medium containing program logic to direct a processor to:
monitor usage of a plurality of applications;
identify usage patterns for each of the plurality of applications;
compare the identified usage patterns with received business objectives; and
output an objective evaluation for each of the applications based upon the comparison, the objective evaluation serving as a basis for maintaining, discontinuing or re-architecting the applications.

15. The apparatus of claim 14, wherein the program logic is further to direct the processor to:
search an architecture repository database in response to the objective evaluation;
identify an architecture in the architecture repository database based upon the received business objectives; and
output a blueprint for re-architecting the application based upon the architecture identified in the architecture repository.
